(19) United States
(12) Patent Application Publication
(10) Pub. No.: US 2020/0324526 A1
(43) Pub. Date: Oct. 15, 2020

(54) RECYCLABLE FILM AND PACKAGING

(71) Applicant: Bemis Company, Inc., Neenah, WI (US)

(72) Inventors: Otacilio T. Berbert, Oshkosh, WI (US); Zheng Tian, Neenah, WI (US); Daniel C. Vennerberg, Neenah, WI (US)

(21) Appl. No.: 16/758,043

(22) PCT Filed: Sep. 27, 2018
(86) PCT No.: PCT/US18/53120

§ 371 Date: Apr. 22, 2020

Related U.S. Application Data
(60) Provisional application No. 62/576,358, filed on Oct. 24, 2017.

(51) Int. Cl. B32B 27/08; B32B 7/12; B32B 27/32; B32B 27/34; B65D 65/40; B65D 77/20; B29C 55/02

(52) U.S. Cl. CPC B32B 27/08; B32B 7/12; B32B 27/32; B32B 27/34; B65D 65/40; B29K 2023/0625; B29C 55/023; B32B 2250/40; B32B 2250/24; B32B 2439/70; B65D 77/2024

(57) ABSTRACT

A recyclable film contains a base film and a sealant. The base film has at least one layer containing a polar polymer and at least one layer containing a polar polymer compatibilizer. Additionally the base film has been oriented and annealed such that it exhibits free shrink of less than 10% in both the machine direction and the transverse direction when, exposed to heat of 90° C. This film has advantages over prior recyclable films in efficient film manufacturing, high quality package production and superior package performance.

### TECHNICAL FIELD

This application relates to films that can be easily recycled. More specifically, high performance packaging films that can be recycled in the polyethylene recycling stream are disclosed.

### BACKGROUND

Today, many products such as consumer goods, foods, beverages, pharmaceuticals, industrial chemicals, cleaners, cosmetics and other sensitive items are packaged in high performance packaging. This packaging provides advantages such as high barrier and hermetic seals to help protect and extend the shelf life of the packaged product. The packaging may also include features for consumer ease, such as opening or reclosing features. Materials used to manufacture these packages must endure the package formation process, package filling conditions and environmental stresses from storage, shipping and distribution. These demands are generally met by multilayer packaging that incorporates several different high-performance materials.

In many cases, high performance packaging is designed with exterior layers such as OPET (biaxially oriented polyethylene terephthalate) or BON (biaxially oriented nylon) which provide high stiffness, dimensional stability and heat resistance. High performance packaging also may include barrier materials such as aluminum foil, PVdC (polyvinylidene chloride) or EVOH (ethylene vinyl alcohol copolymer). These materials are added to a structure that also includes polymers specific for sealing, polymers designed to bind the structure together, printing inks, and adhesives, to name a few. The combination of these various materials creates a film that is very difficult to recycle in available recycling streams. As a result, these packaging films are typically considered “waste” after the package has been emptied.

All polyethylene type structures have been developed for some packaging applications to ease recyclability. Processing techniques such as orientation have been added to the functionality of these materials to improve the technical performance. However, these films and packages continue to suffer in performance. Often the packages have poor appearance due to lack of heat resistance and low durability. These types of structures also have inefficiencies in film conversion, thus driving the cost to manufacture higher.

In some cases, compatibilizers are added to various layers of the packaging film to assist with the incorporation of multiple materials into a single material recycling. stream. The film structures continue to lack the properties to match the non -recyclable high-performance packaging materials that are sold today. Improvements are needed to achieve high performance packaging film materials that can 1) be efficiently converted, 2) have a comparable cost to current films, 3) be used on existing packaging equipment, 4) have acceptable appearance and 5) be efficiently recycled into the polyethylene recycling stream.

### SUMMARY

High performance flexible packaging is designed to deliver speed, performance and cost efficiency in both the process to manufacture the packaging material and the process to manufacture a finished package. High performance packaging also provides protection to the products inside while maintaining an impressive appearance. Typically, high performance packaging materials are designed with a combination of materials to achieve these requirements. Unfortunately, this combination of materials often makes the packaging material difficult or impossible to recycle into a standard reprocessing or recycling stream. Described herein is a recyclable film having properties such that the film can be used for high performance packaging applications, without the disadvantages often experienced with currently available recyclable film.

A recyclable film may have a base film with a) a first polar layer containing a polar polymer, and b) a compatibilizer layer containing a polar polymer compatibilizer. The recyclable film also has a sealant and, optionally, printed indicia located between the base film and the sealant. The base film of the recyclable film is oriented and annealed such that the base film has a free shrink value of less than 10% in both the machine direction and the transverse direction when tested according to ASTM D2732 using bath temperature of 90° C.

In some eases, the polar polymer of the base film is a polyamide or an ethylene vinyl alcohol copolymer. The first polar layer may be an outer layer of the base film. Additionally, the first polar layer may be an outer layer of the recyclable film.

Some embodiments of the recyclable film have a base film that has a free shrink value of less than 5% in both the machine direction and the transverse direction when tested according to ASTM D2732 using bath temperature of 90° C. The sealant of the recyclable film may be a film that has free shrink of less than 1% in the machine direction and a free shrink of less than 1% in the transverse direction.

In some embodiments of the recyclable film, the base film has a) a first polar layer containing a first polar polymer, b) a second polar layer containing a second polar polymer, and c) a compatibilizer layer located between the first polar layer and the second polar layer, the compatibilizer layer containing a polar polymer compatibilizer. The recyclable film also has sealant and may have printed indicia between the base film and the sealant.

In some recyclable films, the base film is oriented and annealed such that the base film has a free shrink value of less than 10% in both the machine direction and the transverse direction tested according to ASTM D2732 using bath temperature of 90° C. The base film may have been oriented such that the machine direction elongation at break of the base film is less than 100%.

In some specific embodiments, the recyclable film has a base film with a) a first outer layer containing a polyamide, b) a compatibilizer layer, c) a first tie layer located between the first outer layer and the compatibilizer layer, d) a second outer layer comprising a polyamide, and e) a second tie layer located between the compatibilizer layer and the second outer layer. The compatibilizer may contain a low molecular weight anhydride or carboxylic acid functionalized polyethylene and a polyethylene, polyethylene copolymer or blends thereof. The polyethylene in the compatibilizing layer may be a LLDPE. The recyclable film may further have a sealant.

The base film of the recyclable film may be oriented and annealed such that the base film has a free shrink value of less than 10% in both the machine direction and the transverse direction when tested according to ASTM D2732 using bath temperature of 90° C.

Some recyclable film embodiments further comprise a barrier material between the base film and the sealant. Some recyclable film embodiments further comprise a second sealant, such that the base film is located between the sealants.

Also disclosed herein are packages that use a recyclable film described herein, and optionally additional packaging components. The recyclable film may be heat sealed to either itself or the additional packaging components and the heat seal strength is between 200 g/in and 2,500 g/in when tested according to ASTM F88. In some embodiments of the package, the recyclable film is configured to be separated from the other packaging components that may be present. In some embodiments, the package is configured to be opened for complete product removal.

### BRIEF DESCRIPTION OF THE DRAWINGS

The disclosure may be more completely understood in consideration of the following detailed description of various embodiments of the disclosure in connection with the accompanying drawings, in which:

FIG. 1 is a cross-sectional view of a first embodiments base film for a recyclable film;

FIG. 2 is a cross-sectional view of a second embodiment of a base film for a recyclable film;

FIG. 3 is a cross-sectional view of a third embodiment of a base film for a recyclable film;

FIG. 4 is a cross-sectional view of a first embodiment of a recyclable film;

FIG. 5 is a cress-sectional view of a second embodiment of a recyclable film;

FIG. 6 is a cross-sectional view of a third embodiment of a recyclable film; and

FIGS. 7a and 7b are schematic views of embodiments of a package that use a recyclable film as a lid.

The drawings show some but not all embodiments. The elements depicted in the drawings are illustrative and not necessarily to scale, and the same (or similar) reference numbers denote the same (or similar) features throughout the drawings.

### DETAILED DESCRIPTION

High performance flexible packaging is designed to deliver speed, performance and cost efficiency in both the process to manufacture the packaging material and the process to manufacture a finished package. High performance packaging also provides protection to the products inside while maintaining an impressive appearance. Typically, high performance packaging materials are designed with a combination of materials to achieve these requirements. Unfortunately, this combination of materials often makes the packaging material difficult to recycle into a standard reprocessing or recycling stream.

In recent years, packaging materials have been developed with recycling in mind. However, these materials often fall short of delivering the standard requirements of product protection, good appearance and low cost. The recyclable films described herein use an oriented and annealed film, that combines polar polymers and compatibilizers, as a base film in combination with a sealant to design a high performance packaging film that meets both recycling and performance criteria. The packages described herein are made with recyclable films that are designed to have high barrier, excellent appearance (clarity), good heat resistance (low shrink), high quality graphics, and good durability. The recyclable films described herein have superior performance to recyclable films available in the market today.

The recyclable films, as well as packages and/or containers including such films, preferably have seal strength, thermal stability, and heat resistance properties that allow them to be subjected to heat sealing conditions without loss of desired functional and visual characteristics. Recyclable films that contain base films that contain polar polymers and are oriented and annealed show improved properties with respect to heat resistance, appearance and overall performance as compared to other recyclable films.

The recyclable films described herein use a base film that has a combination of various layers, including but not limited to, a polar layer and a compatibilizer layer. The base film is oriented and annealed. The materials in the base film and the processing techniques to manufacture the base film combine to create a cost effective and high performance film with good heat resistance, low shrink, and dimensional stability.

The base film contains at least one polar layer that contains a polar polymer. The term “layer”, as used herein, refers to a building block of films that is a structure of a single material type or a homogeneous blend of materials. A layer may be a single polymer, a blend of materials within a single polymer type or a blend of various polymers, may contain metallic materials and may have additives. Layers may be continuous with the film or may be discontinuous or patterned. As used herein, the term “polar polymer” is used to denote a polymer farmed from at least one monomer that comprises at least one heteroatom, such as oxygen (O), nitrogen (N), phosphorus (P) or sulfur (S). Non-limiting examples of polar polymers that are typically used in packaging applications are polyamide and ethylene vinyl alcohol copolymers. The polar layer may contain more than one polar polymer. In addition to the polar polymer, the polar layer may contain other materials such as other polymers or additives, such as slip or antiblock. Preferably, the polar layer is made of at least 50% polar polymer, or more preferably more than 70%, more than 80%, more than 90% or more than 95% polar polymer.

In some embodiments, the polar polymer in the polar layer may be a polyamide. The term “polyamide” refers to a high molecular weight polymer having amide linkages (—CONH—)ₙ which occur along the molecular chain, and includes “nylon” resins which are well known polymers having a multitude of uses including utility as packaging films. Examples of nylon polymeric resins for use in food packaging and processing include: nylon 66, nylon 610, nylon 66/610, nylon 6/66, nylon 11, nylon 6, nylon 66T, nylon 612, nylon 12, nylon 6/12, nylon 6/69, nylon 46, nylon 6-3-T, nylon MXD-6, nylon MXDI, nylon 12T and nylon 6I/6T. Examples of polyamides include nylon homopolymers and copolymers such as nylon 4,6 (poly(tetramethylene adipamide)), nylon 6 (polycaprolactam), nylon 6,6 (poly(hexamethylene adipalilide)), nylon 6,9 (poly(hexamethylene nonanediamide)), nylon 6,10 (poly(hemimethylene sebacamide)), nylon 6,12 (poly(hexamethylene dodecanediamide)), nylon 6/12 (poly(caprolactam-co-dodecanediamide)), nylon 6,6/6 (poly(hexamethylene adipamide-co-caprolactam)), nylon 66/610 (e.g., manufactured by the condensation of mixtures of nylon 66 salts and nylon 610 salts), nylon 6/69 resins (e.g., manufactured by the condensation of epsilon-caprolactam, hexamethylenediamine and azelaic acid), nylon 11 (polyundecanolactam), nylon 12 (polylauryllactam) and copolymers or mixtures thereof.

Polyamide is used in films for food packaging and other applications because of its unique physical and chemical properties. Polyamide is selected as a material to improve temperature resistance, abrasion resistance, puncture strength and/or barrier of films. Properties of polyamide-containing films can be modified by selection of a wide variety of variables including copolymer selection, and converting methods (e.g. coextrusion, orientation, lamination, and coating).

In some embodiments, the polar polymer in the polar layer is ethylene vinyl alcohol copolymer (EVOH). As used herein, “EVOH” refers to ethylene vinyl alcohol copolymer. EVOH is otherwise known as saponified or hydrolyzed ethylene vinyl acetate copolymer, and refers to a vinyl alcohol copolymer having an ethylene comonomer. EVOH is prepared by the hydrolysis (or saponification) of an ethylene vinyl acetate copolymer. The degree of hydrolysis is preferably from about 50 to 100 mole percent, more preferably from about 85 to 100 mole percent, and most preferably at least 97%. It is well known that to be a highly effective oxygen barrier, the hydrolysis-saponification must be nearly complete, i.e., to the extent of at least 97%. EVOH is commercially available in resin form with various percentages of ethylene. It is expected that processability and orientation would be facilitated at higher ethylene contents; however, gas permeabilities, particularly with respect to oxygen, may become undesirably high for certain packaging applications which are sensitive to microbial growth in the presence of oxygen. Conversely, lower ethylene content may have lower gas permeabilities, but processability and orientation may be more difficult. In some embodiments, ethylene-vinyl alcohol copolymers comprise from about 27-48 mole % ethylene, 27-44 mole % ethylene, or even 27-29 mole % ethylene. EVOH may be further optimized by blending, special copolymerization or crosslinking to be more heat resistant or enhance other properties.

In some embodiments of the recyclable film, the base film has at least two polar layers. The base film could have one, two or more polar layers. The polar layers may be separated by compatibilizer layers, tie layer or other layers, as will be described. In the case where the base film does contain more than one polar layer, the polar layers may have the same composition or different composition. For instance, the base film may have one polar layer that contains polyamide and a second polar layer that contains EVOH. In some embodiments, the base film contains two polar layers, each containing polyamide.

By nature of their chemical makeup, many polar polymers typically used for the production of films have generally different properties as compared to non-polar polymers (i.e. those polymers containing only carbon atoms in the polymer backbone). Polar polymers can provide better oxygen barrier, increased stiffness or increased heat resistance. Additionally, these properties may be enhanced upon orientation, as will be discussed below.

It has been unexpectedly found that a base film containing two layers of polyamide separated by a compatibilizer layer and machine direction oriented and annealed, can be used to manufacture a packaging film that has similar machineability and packaging line efficiency as the current packaging structures that use BON or OPET. The addition of the compatibilizer layer surprisingly did not negatively affect the performance of the oriented base film. Advantageously, the film using two polyamide layers can be manufactured at a lower cost. The addition of a polar polymer compatibilizer to the layer that separates the two polyamide layers adds the functionality of recyclability to the film, creating a significant advantage, without compromising the physical properties of the film.

Advantageously, one or both outer layers of the base film may be polar layers. Reference to “outer layer” as used herein refers to the layers of a film that are on either major surface of the film, i.e. the layers that are not between two other layers of that film. In some embodiments, both outer layers of the base film are polar layers. In some embodiments, both outer layers of the base film are polar layers that contain polyamide.

In some embodiments, the outer layer of the base film is also the outer layer of the recyclable film. In other words, the base film is an outer film of the recyclable film and no other films or layers are applied to the outer layer of the base film. In some embodiments, the outer layer of the base film and the outer layer of the recyclable film is a polar layer. Ideally, the outer layer of the base film and the outer layer of the recyclable film is polyamide.

The polar layers may be of any thickness. Typically, a polar layer represents at least 2% of the total base film thickness before orientation

The compatibilizer layer of the base film contains materials, “compatibilizers”, that are able to assist in the incorporation of polar materials into a reprocessing or recycling stream of non-polar polymers. The compatibilizer generally increases the stability of the dispersed polar material by providing sites that allow the two materials (polar and non-polar) to interact, increasing miscibility. Use of a compatibilizer in a blend of polar and non-polar materials generally creates a more homogeneous blend, avoiding gels and other issues that cause visual or mechanical property quality issues.

An example of a compatibilizer that can be used in the compatibilizer layer is Retain 3000, available from The Dow Chemical Company. The details of this material and the use of it as a compatibilizer for polar materials is outlined in patent document WO16109023, Parkinson et at (i.e. '023), which is incorporated herein by reference. However, the films disclosed in '023, do not include any form of oriented films, thus lacking in dimensional stability and stiffness required for many high-performance packaging applications.

In some embodiments of the base film, the compatibilizer layer is a blend of polyethylene and a low molecular weight anhydride or carboxylic acid functionalized polyethylene.

While the examples and description of polar polymers herein includes polyamide and EVOH, the polar layers of the recyclable film are not to be restricted to these materials. While the examples and description of the compatibilizers include materials that compatibilize polyamide and EVOH into non-polar polymer recycling streams, the compatibilizers of the recyclable film are not to be restricted to these materials. Another polar polymer may be used along with a functional compatibilizer suited to that polar polymer and it is still within the spirit of this disclosure.

Polyethylene is the name for a polymer whose basic structure is characterized by the chain —(CH2—CH2)ₙ. As used herein, the term “polyethylene” includes homopolymers and copolymers of ethylene. Polyethylene homopolymer is generally described as being a solid which has a partially amorphous phase and partially crystalline phase with a density of between 0.900 to 0.970 g/cm3. The relative crystallinity of polyethylene is known to affect its physical properties. The amorphous phase imparts flexibility and high impact strength while the crystalline phase imparts a high softening temperature and rigidity.

There are several broad categories of polymers and copolymers referred to as “polyethylene.” Placement of a particular polymer into one of these categories of polyethylene is frequently based upon the density of the polyethylene and often by additional reference to the process by which it was made since the process often determines the degree of branching, crystallinity and density. In general, the nomenclature used is nonspecific to a compound but refers instead to a range of compositions. This range often includes both homopolymers and copolymers.

“High density polyethylene” (HDPE) is ordinarily used in the art to refer to both (a) homopolymers of densities between about 0.960 to 0.970 g/cm3 and (b) copolymers of ethylene and an α-olefin (usually 1-butene or 1-hexene) which have densities between 0.940 and 0.958 g/cm3. HOPE includes polymers made with Ziegler or Phillips type catalysts and is also said to include high molecular weight polyethylene.

“Medium density polyethylene” (MDPE) typically has a density from 0.928 to 0.940 g/cm3. Medium density polyethylene includes linear medium density polyethylene (LMDPE).

Another grouping of polyethylene is “high pressure, low density polyethylene” (LDPE). LDPE is used to denominate branched homopolymers having densities between 0.91 5 and 0.930 g/cm3. LDPEs typically contain long branches off the main chain (often termed “backbone”) with alkyl substituents of 2 to 8 carbon atoms.

“Linear low density polyethylene” (LLDPE) are copolymers of ethylene with alpha-olefins having densities from 0.915 to 0.940 g/cm3. The alpha-olefin utilized is usually 1-butene, 1-hexene, or 1-octene and Ziegler-type catalysts are usually employed (although Phillips catalysts are also used to produce LLDPE having densities at the higher end of the range, and metallocene and other types of catalysts are also employed to produce other well-known variations of LLDPEs). An LLDPE produced with a metallocene or constrained geometry catalyst is often referred to as “mLLDPE”. In some specific embodiments, the compatibilizer layer of the base film may have a blend of LLDPE and a compatibilizer.

Other examples of polyethylene copolymers include, but are not limited to, ethylene vinyl acetate copolymer (EVA), ethylene methyl methacrylate copolymer (EMMA), ethylene-methacrylic acid (EMAA) and ethylene acrylic acid (FAA).

The base film also may have one or more layers for the functionality of adhesion, such as tie layers or adhesive layers. The term “tie layer,” “adhesive”, “adhesive layer,” or “adhesive coating,” refers to a material placed on one or more layers, partially or entirely, to promote the adhesion of that layer to another surface. A “tie layer” refers to a polymeric based material that is coextruded with other layers for the purpose of providing adhesion between two other layers. In the base film of the recyclable film, a tie layer may be positioned between the polar layer and the compatibilizer layer. Tie layers may also be used to provide adhesion for any other layers that may be present in the base film. The tie layers may also contain materials for other functionality such as moisture barrier. In some embodiments, the tie layer(s) in the base film contains an ethylene based polymer that has maleic anhydride grafted functionality.

“Adhesive”, “adhesive layers” or “adhesive coatings” are positioned between two films or layers to maintain the two materials in position relative to each other and prevent undesirable delamination. Unless otherwise indicated, an adhesive layer or a coating can have any suitable composition that provides a desired level of adhesion with the one or more surfaces in contact with the adhesive layer material.

The base film of the recyclable film may contain other functional layers, such as bulk layers, layers for pigmenting, or barrier layers, as long as the content of these layers does not frustrate the recyclability of the overall film. Specifically, layers of the base film may contain recycled content such as post-consumer recycle or post-industrial recyclate. Specifically, a layer of the base film may contain reprocessed scrap, such as edge trim, from the production of the base film or recyclable film itself (i.e. closed loop industrial recycling).

Non-restricting embodiments of the base film are shown in FIGS. 1, 2 and 3. In FIG. 1, the base film 20 has a polar layer 22 and a compatibilizer layer 24. In this embodiment, the polar layer 22 is directly adjacent to the compatibilizer layer 24, but other embodiments may include intervening layers. Additionally, the polar layer 22 and the compatibilizer layer 24 are each shown as outer layers of the base film. In other embodiments, the polar layer and/or the compatibilizer layer are not outer layers.

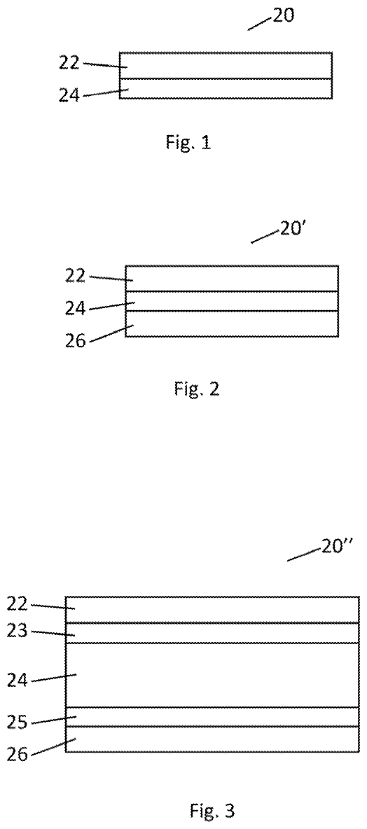

FIG. 2 shows an embodiment of the base film 20′ that includes two polar layers. The first polar layer 22 is shown as a first outer layer of the base film and the second polar layer 26 is shown as a second outer layer of the base film. Compatibilizer layer 24 is shown in the preferred location, between the first and second polar layers. As discussed previously, the first and second polar layers may have the same or different composition.

FIG. 3 shows an embodiment of the base film 20″ that includes a first tie layer 23 between the first polar layer 22 and the compatibilizer layer 24, and a second tie layer 25 between the second polar layer 26 and the compatibilizer layer 24. The composition of the first and second polar layers may be the same or different. The composition of the first and second tie layers may be the same or different. In some embodiments, the composition of the first polar layer and the second polar layer are identical, the composition of the first tie layer and the second tie layer are identical, and the layer thickness are such that the base film is palindromic.

FIGS. 1, 2 and 3 show the preferred embodiments of the base film having the polar layer 22 as an outer layer of the base film 20. However, this is not restrictive and there may be other layers as the outer layers of the base film 20 on either or both outer layers.

As shown in FIGS. 1, 2 and 3, the compatibilizer layer (or layers) are in close proximity to the polar layers. Incorporation of compatibilizer into the recyclable film structure allows for efficient use of the compatibilizer as the amount can be exactly matched to the amount of polar polymer in the structure. Ideally, the compatibilizer layer should be within the same base film structure as the polar layer. The compatibilizer layer should be close to the polar layer, with ideally, only a tie layer intervening between the two layers. This allows the compatibilizer to be readily available to the polar polymer at the time of recycling and reprocessing. When the compatibilizer is close to the polar polymer, it is most efficiently used (i.e. the optimal minimum amount of compatibilizer is necessary). Locating the compatibilizer layer in close proximity to (near) the polar polymer is a configuration of the base film such that the recyclable film may be recycled in a polyethylene recycling stream without the need for additional compatibilizer. Locating the compatibilizer layer between the first and second polar layers is an example of a configuration of the base film that allows the recyclable film to be recycled in a polyethylene recycling stream without the need for additional compatibilizer.

Advantageously, the polar layers of the base film are spaced from each other by polyethylene based layers, such as tie layers or compatibilizer layers. This type of structure has an effect on the stiffness of the film, especially after orientation of the base film. An oriented and annealed base film of this type of structure (such as those shown as A/BA of FIG. 2 or A/C/B/C/A of FIG. 3 structure) has stiffness that matches oriented films typically used on “non-recyclable” high performance packaging, such as oriented polyester (OPET) or biaxially oriented nylon (BON). While retaining the stiffness as compared to OPET or BON, some embodiments of the base film of the recyclable films additional have the advantage of recyclability in a polyethylene reprocessing stream and are often lower cost.

The base film may be of any thickness.

Production of the base film requires at least the conversion processes of extrusion, orientation and annealing. These processes, in combination with raw material selection, can impart critical properties such as thermal stability and durability. Additionally, the film can be more cost effective than inn-oriented materials or oriented materials made from a single polymer.

The layers of the base film can be extruded either in combination (coextrusion) or separately. If done separately, the layers can be combined by known methods of lamination including adhesive lamination or extrusion lamination. Alternatively, layers of the base film can be added by extrusion coating, solution coating, or any other known converting method. A combination of extrusion and lamination processes may be used to manufacture the base film. The base film, or any particular layers of the base film, may be extruded using either flat or annular die type processes.

After all the layers of the base film have been assembled, orientation of the film is performed. Orientation may be mono-directional (machine direction or transverse direction), or bi-directional stretching of the film, increasing the machine direction and/or transverse direction dimension and subsequently decreasing the thickness of the material. Bi-directional orientation may be imparted to the film simultaneously or successively. Stretching in either or both directions is subjected to the film in the solid-phase at a temperature just below the melt temperature of the polymers in the film. In this manner, the stretching causes the polymer chains to “orient”, changing the physical properties of the film. At the same time, the stretching thins the film. The resulting films are thinner, and can have significant changes in mechanical properties such as toughness, heat resistance, stillness, tear strength and barrier.

The amount of orientation imparted on the base film can affect the properties thereof. It has been found that in the ease of a machine direction oriented base film, stretching of at least 2× (2 times) leads to optimal film properties, such as stiffness and appearance. However, in some embodiments the base film may be stretched to a level less than 2×. In other embodiments the base film may be machine direction stretched at least 2.59×, 3.0×, 3.5×, 4×, 5×, 6×X, any value in between these, or more. In other words, the dimension of the film is increased 2 times the original length, increased 2.5 times the original length, etc. Biaxially oriented base films may be stretched at similar levels as mono-oriented films, through either a tented-frame process (flat die) or a bubble process (tubular die).

Also important to the properties of the base film is the annealing process. After orientation, the films have an embedded stress. Upon heating the film, this stress may be released, causing the films to shrink back to their original, pre-orientation, size. This may be problematic when applying beat to the base film during the process of heat sealing the recyclable film in a packaging application. Shrinkage of the base film at this point will result in a poor appearance in the heat seal area of the package. Additionally, a film that exhibits shrink under heat conditions will be very difficult to apply printed indicia, as this process generally uses high temperatures. The process of annealing can help alleviate the embedded stress caused by orientation and the film will be “heat set” such that it will not shrink back to the original size at lower operating temperatures. It has been found that annealing the film at a temperature of about 120° C. using annealing rollers, results in a base film that can be converted easily (printed/laminated/etc.) and is capable of being part of a recyclable film that can be heat sealed to other packaging components without detrimental visual effects.

The base film may be oriented and annealed in line. The base film may be biaxially oriented and annealed in line using known processes, such as the triple bubble process. The base film may be coextruded on a flat die system with machine direction orientation and annealing in-line. The base film may be coextruded on a flat dies system and machine direction stretched followed by transverse direction stretched (i.e. tenter frame orientation process) and annealed in-line. Alternatively, the processes of orientation and annealing may be done in separate processes. Annealing is typically accomplished in-line through high diameter rollers set up at temperatures a few degrees lower than the melting point of the polymer or blend of polymers present in the film. However, annealing can be done by any known means including hot air or IR heating.

The recyclable films disclosed herein also include a sealant. As used herein, a “sealant” is a material, layer or film that allows the recyclable film to be bonded to itself or other packaging components, forming a package. A sealant may form a bond under the influence of pressure or heat or a combination of these conditions. A sealant may be in the form of a film or a coated layer and may be continuous or discontinuous (patterned). Alternatively, the base film may perform the function of the sealant. Embodiments of the recyclable film may include any known sealants such as, but not limited to, adhesives, hot melt, cold seal materials, heat seal films, and heat seal coatings.

The sealant may be a material applied as a heat seal coating. Heat seal coatings are typically thin and may be pattern applied. Many different types of heat seal coatings can be used without hindering the recyclability of the film due to the small amount of sealant material required. Heat seal coatings may be, but are not limited to, polyester based formulas, vinyl/acrylic copolymer based formulas, or polypropylene based formulas. Heat seal coatings may contain low melt temperature components such as waxes. Heat seal coatings that contain wax components may have heat seal initiation temperatures of 60° C. or even lower. The sealant on the recyclable film may have a heat seal initiation temperature that is less than 60° C., 85° C., 100° C. or less than 121° C.

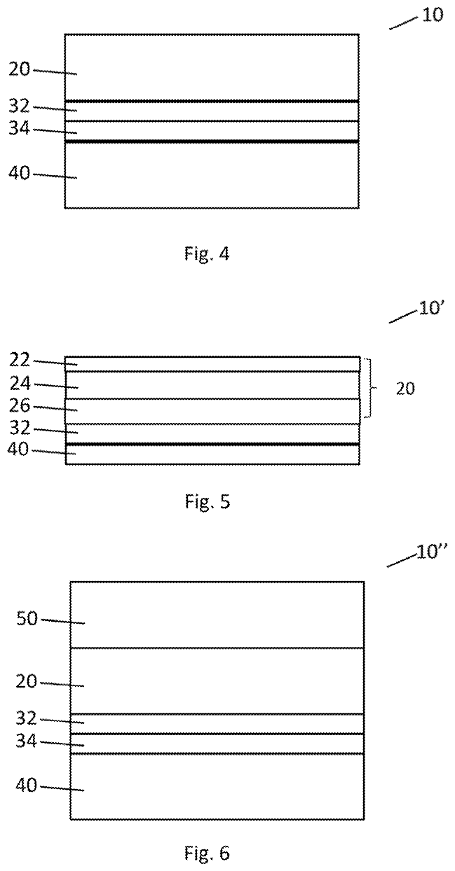

Heat seal coatings may be applied to the recyclable film in any process known. The heat seal coating, or any other type of sealant, may be applied directly to the outer layer of the base film. The heat seal coating may be applied directly to an outer polar layer of the base film. Alternatively, there may be intervening materials between the base film and the sealant, such as, but not limited to, printed indicia, barrier materials, primers or adhesives, FIG. 4 shows an embodiment of the recyclable film 10 that has a base film 20 and a sealant 40. Between the base film and the sealant are optional layers of printed indicia 32 and adhesive 34. This embodiment is an optimal arrangement of materials for high performance packaging films, allowing for optimal positioning of the abuse resistant base film (on the exterior), the printed indicia (viewable through the base film yet protected from environmental conditions) and the sealant material (allowing for sealing as the outer layer of the film).

The sealant of the recyclable film may be a polymeric based film, manufactured in a separate process, and subsequently adhered to the base film. Alternatively, a sealant film may be extruded and simultaneously attached to the base film in an extrusion coating type operation. Sealant films may be monolayer or multilayer and may be produced by any known processes. Ideally, the sealant film has not been oriented and has no embedded stress (i.e. the sealant film has zero or near zero free shrink). Alternatively, the sealant may be oriented, as well as fully or partially annealed.

The sealant film may contain any type of material that will allow for bonding during a package production operation. Sealing materials need to be chosen based on the process to be used for sealing and the material/component that the recyclable film will be sealed to. Typical materials used for heat sealing include linear low density polyethylenes, ionomers and ethylene vinyl acetate copolymers, but may be chosen from a wide variety of known sealant materials.

Certain embodiments of the recyclable film include a multilayer sealant film that incorporates other layers such as barrier layers, bulk layers, mechanical strength layers, pigmented layers, etc. In fact, the sealant film may even include additional polar layers along with additional compatibilizer layers.

FIG. 5 shows a preferred embodiment of the recyclable film 10′. The base film 20 has two outer polar layers 22, 26 and a compatibilizer layer 24 between them. The outer polar layer 26 has printed indicia 32 applied to it, followed by a sealant 40. This arrangement provides superior heat resistance and appearance in a high performance recyclable packaging film. Again, the printed indicia is optional, and there may be other layers between the base film and the sealant, such as adhesive, barrier layers or primers.

The sealant of the recyclable film may be designed for other functionality. Sealants often contain additives such as slip or antiblock. Sealants also may have antifog properties, easy tear properties, high opacity agents, pigments anti-scalping properties, or high barrier properties, including but not limited to oxygen or moisture barrier. For example, a recyclable film may contain titanium dioxide (TiO₂) to increase opacity and stiffness for flow wrap applications.

The sealant may also be formulated to provide a peelable seal. As used herein, a “peelable seal” is one that can be separated manually (i.e. by hand without the use of a tool). Seal strength may be tested using ASTM F88 and a peelable seal may result in a force of between 200 and 2,500 g/in. Often, peelable seals are used for consumer convenience. In the case of a recyclable film used as a packaging component, peelable seals may be highly desired such that the recyclable film may be easily separated from the remainder of the packaging components, facilitating easy recycling. In some cases, the other packaging components that may be present may be recycled in the same stream, may be recycled in a different stream, may be designed for disposal (waste stream) or may be designed for reuse without recycling.

In some embodiments the recyclable film may incorporate a first and second sealant, as shown in FIG. 6. Here, recyclable film 10″ has base film 20, with optional printed indicia 32 and adhesive 34. There is a first sealant 40 and a second sealant 50, positioned as the outer layers of the recyclable film 10″. In this manner, the recyclable film can be sealed on both sides, allowing for lap sealing (sealing one side of the film to the other side) or attachment of packaging components (such as fitments) to both sides of the recyclable film.

The recyclable film may also include a barrier material for decreasing the transmission rate of gases or other vapors through the film structure. Many high-performance packaging structures include barrier materials such as EVOH, foil, metalized films, PVdC, polyamide or oxide coated films to achieve the low transmission rates required for extending the shelf life of the product packaged. Many packaged foods and pharmaceuticals (as well as other products) are sensitive to their environment and require a very limited transmission rate through the packaging components. Typically, the barrier materials or barrier layers are tuned to low transmission of oxygen or moisture. A barrier material may be incorporated into the recyclable film in any location.

There may be a barrier layer located within the base film of the recyclable film. A non-limiting example is a base film with at least one polar layer containing EVOH. EVOH has excellent oxygen barrier, which is enhanced upon orientation. EVOH in the base film could provide an improved effect of good barrier, good heat resistance, good thermal stability, printability and good appearance. Additionally, locating the EVOH in the base film in close proximity to the polar polymer compatibilizer creates a material that can be efficiently recycled, without the need for additional compatibilizer.

In some embodiments, there may be a barrier layer within the sealant of the recyclable film. Traditional non recyclable high-performance packaging materials often use extrudable barrier materials such as EVOH or polyamide multilayer sealant films. This type of sealant film structure could be incorporated into the recyclable films as well, if there is enough compatibilizer in the recyclable film to allow for recycling of the film in the polyethylene recycling stream without the need for additional compatibilizer. Typically, if a polar polymer barrier material is incorporated in the sealant, a compatibilizer should be incorporated into the sealant as well.

In some embodiments of the recyclable film, there may be a barrier layer located between the base film and the sealant. The oriented base film provides an excellent opportunity to apply coatings, as it has the proper heat resistance, low shrink and thermal stability to withstand the processes necessary for applying the barrier. For example, the oriented and annealed base film could go through a metallization process that would deposit a thin layer of aluminum to an outer layer. In some embodiments, the outer layer of the base film may have printed indicia applied followed by a barrier coating. Alternatively, the outer layer of the base film could have a barrier layer applied first, followed by an optional printed indicia application. Barrier coatings may be any known chemistry, such as crosslinked acrylates or partially neutralized acrylic polymers. Thin layers of depositions or coatings may be useful for the recyclable films as the amount of material used can be easily incorporated into the recycling., stream without the need for compatibilizers.

As indicated previously, the recyclable film can incorporate printed indicia. The indicia may be incorporated into the recyclable film in any known process. High performance packaging is typically converted in high speed processes such as rotogravure printing, flexographic printing, or digital printing. For many applications, the printed indicia that is applied to the film is registered with tight repeat tolerances (i.e. each impression of print must be nearly identical in size). The thermal stability of the oriented and annealed base films described herein is useful for these types of printing processes. The base film can have high quality printing applied to either or both outer layers As shown in FIGS. 4, 5 & 6, the printed indicia nay be located between the base film and the sealant, protecting the indicia from external abuse such as scuffing.

The base film may have a primer applied or another treatment (i.e. corona treatment) prior to printing to facilitate good ink wetting and adhesion. Printed indicia applied to the outer layer of the base film that is the outer layer of the recyclable film (opposite the side the sealant is attached to) may also include a protecting layer or another layer to create a visual or tactile effect. The printed indicia may be incorporated as a continuous layer, or applied as a pattern or vignette (an image created by dots). The printed indicia may be continuous with the recyclable film or only cover a small portion of the film. The printed indicia may be visible from either or both sides of the recyclable film.

While the purpose of the proposed recyclable film is to create a material that can be used in high performance packaging applications, the film may also contain materials that have been recycled. Recycled materials such as previously used packaging (post-consumer recyclate) or film converting trim waste (post industrial recyclate) may be incorporated into any portion of the recyclable film. The material may not require compatibilizer or a compatibilizer may be added at the point of incorporation.

The base film, sealant or any other portion of the recyclable film may incorporate any other additives known to be used in packaging films. These additives may include, but are not restricted to, nucleating agents, processing aids, pigments, slip, or antiblock. Additives may also be “active” in nature, with the intended purpose of interacting with the environment. One example of an active additive is an oxygen absorber.

The recyclable film may have any overall thickness as necessary for the application in which it will be employed. Recyclable films for packaging applications may have a thickness from 1 mil (25.4 micron) to 20 mil (508 micron). The thickness of the recyclable film may be from 1.5 mil (38.1 micron) to 10 mil (254 micron), or from 2 mil (51.7 micron) to 5 mil (127 micron).

The stiffness of the base film and the recyclable film is an important attribute of the recyclable films described herein. The oriented base film provides for improved stiffness over previously described recyclable packaging webs. Some embodiments that incorporate a base film that has two polar layers separated by a non-polar layer (i.e. the compatibilizer layer) exhibit especially good stiffness characteristics. Surprisingly, it was found that the stiffness of the base films described herein mimics, or in some cases improves, the stillness found in current non-recyclable packaging structures that incorporate OPET or BON. The stiffness of the recyclable film may be critical to successful converting of the film on packaging equipment used today. In this manner, adoption of the recyclable film into current packaging applications can be made without higher costs or process inefficiencies. Additionally, the stiffness of a film used as packaging can provide a perception of higher quality and is valued by consumers. Stiffness of the recyclable film or the base film can be measured by a loop stiffness test.

The recyclable films described herein have heat resistance to be used as high-performance packaging films. The base film is configured to withstand high temperatures that the packaging film may encounter, such as, but not limited to, heat from film converting, high temperature heat seal units, high temperature processing such as hot fill or retort, or high temperature consumer use such as microwaving. Heat resistance is evident by low shrink, among other properties. When experiencing a high heat environment, the recyclable film should not shrink or otherwise distort. For example, the heat seal areas on a high-performance package should be smooth and clean, without marring or any indication of shrinking or puckering.

The recyclable films disclosed herein are superior to previously developed recyclable films. Films that utilize only polyethylene materials are prone to scuffing and durability issues. Films that utilize polar materials such as polyamide have increased heat resistance and durability, but still may fall short of currently available non-recyclable films. However, the recyclable films described herein have heat resistance and durability that mimics non-recyclable films that have BON or OPET exterior layers. The embodiments that employ oriented and annealed base films with outer layers of polar materials are especially advantageous for achieving recyclable films that can be used high performance packaging that can be converted and distributed while retaining very good appearance.

The material selection and processing conditions disclosed herein are critical to achieving a low shrink, heat resistant material. Using polar polymers, such as polyamide, in the base film, in combination with orientation and annealing at the proper conditions, creates a film that exhibits low shrink and good thermal stability at conditions of interest. An analytical approach to testing a materials suitability for high performance packaging applications is a free shrink, described herein. The base film may have a machine direction shrink rate of 10% or less than 10% upon application of heat less than or equal to 90° C.; or less than 9%, less than 8%, less than 7%, less than 6%, less than 5%, less than 4%, less than 1%, less than or less than 1%. The base film may have a transverse direction shrink rate of 10% or less than 10% upon application of heat less than or equal to 90° C.; or less than 9%, less than 8%, less than 7%, less than 6%, less than 5%, less than 4%, less than 3%, less than 2%, or less than 1%. Preferably, the base film has a machine direction shrink rate of less than 7% and a transverse direction shrink rate of less than 1%, when exposed to heat less than or equal to 90° C. Preferably, the base film has a machine direction shrink rate of less than 5% and a transverse direction shrink rate of less than 5%, when exposed to heat less than or equal to 90° C. The base film may have a shrink rate of less than 2% in the machine direction and 0% in the transverse direction when exposed to heat of 90° C. The base film may have a shrink rate of less than 1% in the machine direction and 0% in the transverse direction when exposed to beat of 90° C.

Similarly, the recyclable film may have a machine direction shrink rate of 10% or less than 10% upon application of heat less than or equal to 90° C.; or less than 9% less than 8%, less than 7%, less than 6%, less than 5%, less than 4%, less than 3%, less than 2%, or less than 1%. The recyclable film may have a transverse direction shrink rate of 10% or less than 10% upon application of heat less than or equal to 90° C.; or less than 9%, less than 8%, less than 7%, less than 6%, less than 5%, less than 4%, less than 3%, less than 2%, or less than 1%. Preferably, the recyclable film has a machine direction shrink rate of less than 7% and a transverse direction shrink rate of less than 1%, when exposed to heat less than or equal to 90° C. Preferably, the recyclable film has a machine direction shrink rate of less than 5% and a transverse direction shrink rate of less than 5%, when exposed to heat less than or equal to 90° C. The recyclable film may have a shrink rate of less than 2% in the machine direction and 0% in the transverse direction when exposed to heat of 90° C. The recyclable film may have a shrink rate of less than 1% in the machine direction and 0% in the transverse direction when exposed to heat of 90° C.

As has been discussed, the recyclable film may contain a barrier layer or barrier material. The recyclable film may exhibit high oxygen or moisture barrier as may be required by packaging applications. Barrier layers may also protect outer films/layers from migration from package contents (for example, oils and the like). The recyclable film may have oxygen transmission levels of less than 1,000 cm³/m²/24 hours when tested at 0% RH and 23° C. following ASTM F1927. The recyclable film may have oxygen transmission levels less than 100, less than 10, less than 5, or less than 1 cm³/m²/24 hours. The recyclable film may have moisture transmission levels of less than 100 g/m², 24 hours when tested at 90% RH and 23° C. following ASTM F1249. The recyclable film may have moisture transmission levels of less than 10, less than 5, or less than 1 g/m²/24 hours.

For high performance packaging applications, the recyclable film may have near 100% barrier to visible light (opaque to light), or at least 50% barrier to visible light. This type of recyclable film would be appropriate for packaging applications where a view of the product was not desirable or when light is detrimental to the shelf life of the product.

Alternatively, the recyclable film may have high light transmission and clarity, as is often desirable for packaging applications when it is desirable to view the product through the packaging material. The base film may have a clarity of more than 80%, 85% or 90%. Ideally, the base film should have a clarity of at least 95%, at least 95.5%, at least 96%, at least 96.5%, at least 97%, at least 97.5%, at least 98%, at least 98.5%, at least 99%, at least 99.5%, or 100%, and all values there between, when measured in accordance with the instructions and teachings of ASTM D-1003. Clarity is defined as the percentage of transmitted light that deviates from the incident light by less than 2.5 degrees. The clarity of the base film can be affected by material selection and orientation conditions, as is known in the art.

As has been discussed, the appearance of the packaging material is critical performance criteria for many high-performance packaging applications. In addition to high clarity and high quality printed indicia, it is often desirable to have a high gloss exterior. The base film may have gloss levels greater than 50, 60, 70 or even 80 (45° gloss, units, ASTM D2457) which is comparable to other packaging materials such as BON. This type of gloss is superior to recyclable packaging films containing only polyethylene based materials.

The recyclable films containing, base films and sealants described herein may be recycled after their primary use is completed. In general, the term recyclable means that the product is suitable for reuse. An example of one specific context of recyclable is reusing a plastic grocery bag a second time to contain some other items. The plastic bag has been reused and recycled. In a slightly different context, recyclable means that the product is suitable for reuse after being converted into a new product. As used herein, the term “recyclable” is meant to indicate that the film can be converted into a new useful item, by means of reprocessing in a polyethylene waste stream. Reprocessing may entail washing, separating, melting and forming, among many other steps. Typically, when plastic packaging is reprocessed, the material is mechanically chopped into small pieces and then melted to be reformed into the new product. If multiple incompatible materials are present in the packaging, interactions occur during reprocessing causing gels, brittle material, poor appearance and generally un-usable or poor-quality products. Using the term “recyclable” indicates that these drawbacks are generally not present. Qualification as a recyclable material is not regulated by any specific agencies but can be obtained from specific groups such as Association of Plastic Recyclers (APR) and How2Recycle™. Recyclable films disclosed herein may be suitable for “Store Drop-off” recycling streams. These streams may accept the following: 100% polyethylene bags, wraps, and films; very close to 100% polyethylene bags, wraps, and How2Recycle-approved polyethylene-based carrier packing with or without compatibilizer technology. Introduction of a recyclable film into any of these recycling-by-reprocessing avenues should not require additional compatibilizer.

When used as a packaging film, the recyclable film may be sealed to itself, or a similar film, or to one or more other packaging components. Other packaging components may include, but are not limited to zippers, fitments, cups or trays. The packaging may also include other components such as patches, liners, sleeves or labels. The packaged may be formed from one, two, three or more different packaging components.

The recyclable film is sealed, or connected, to itself or other packaging components to create a hermetically sealed package. The seals may be made by adhesives, heat sealing, ultrasome sealing, cold sealing, RF welding or any other known bonding method. Hermetic packaging is critical for a wide variety of products, including foods, beverages, pharmaceuticals, consumer goods and other sensitive, products. Hermetic packaging can help prevent damage to the product. For many products, achieving good heat seals to create consistently hermetic packages is highly critical. An advantage of the recyclable films disclosed herein is that they are more heat resistant and thus can be formed into hermetic packaging on a more reliable basis. The combination of the high heat resistance of the base film and the sealant layers that provide quality seals is an important advantage to the films presented herein.

It is also an advantage, of some embodiments of the recyclable films disclosed herein that they are provided with sealants that achieve peelable seals when heat sealed to other packaging components. Packages can be opened by consumers in many ways, including peeling open manually. Peelable seals are those that can be peeled open by a consumer by hand, without the use of another tool. A consumer can grasp two parts of a package and pull the package open at a heat seal. Peelable seals allow for the product within the package to be easily accessed by the consumer. In some cases, peelable seals can also be manually reclosed and resealed. Additionally, the recyclable films may have peelable heat seals to allow for easy separation of the packaging, components. This advantageously allows for proper disposal of the packaging components into other recycling streams or waste streams. The packaging components included in the hermetically sealed package may be recyclable in the same stream as the recyclable film, recyclable in a different stream or not recyclable at all.

The recyclable film may be used in any sort of hermetic package format including, but not limited to, pouches, bags, flow wrap, trayllid, chub, bulk bag, and blisters. The recyclable film may be used to package any type of product including, but not limited to, dry foods, liquids, meats, cheese, fresh foods, frozen foods, beverages, pharmaceuticals, nutraceuticals, cosmetics, hard-to-hold products, cleaners, chemicals, wipes, medical products, electronic devices, pet foods treats, bulk products, etc.

Some embodiments of packages that use the recyclable films disclosed herein are in the format of a pouch, bag or sachet. In this format, the recyclable film is used as in at least one of the side-walls of the package, or in some cases, all the side walls. A pouch or bag may be sealed in a fin seal or lap seal configuration. A sachet may have side seals and end seals. Fitments or other closures may be sealed to any part of the recyclable film.

Ideally, the package is configured such that after the contents have been emptied, the package may be opened fully, and the packaging components separated as necessary, for optimal emptying (product removal), rinsing, and recycling. Compete product removal means that the package is free from significant amounts of product that would contaminate the recycling process. Complete product removal may be determined by visual inspection. Complete product removal may be accomplished by rinsing the opened packaging components with water until most or all the product has been removed.

The separation of the packaging components may be facilitated by the previously mentioned peelable seals, or by any other means such as weakened lines or perforations that can be torn open. In some cases, the recyclable film and the other packaging components are designed to be easily torn or cut to theilitate opening. In some embodiments, packaging components remain attached to the recyclable film and are capable of being recycled in the same recycling stream.

Some embodiments of the recyclable film may be used in chub style packaging. These films may have sealant on both major surfaces of the recyclable film (shown in FIG. 6) to accommodate lap sealing. The recyclable film may have a very slight amount of machine direction and/or transverse direction shrink, such as 5%, as is optimal for some chub style packaging applications.

The size of the package in which the recyclable film is used is unlimited. The packaging could be very small (a few square inches) or very as is the case for bulk container liners. A bulk liner may be made from a recyclable film and in some embodiments, a bulk liner may be made from several plies of recyclable film. The bulk liners may have fitments attached to either surface.

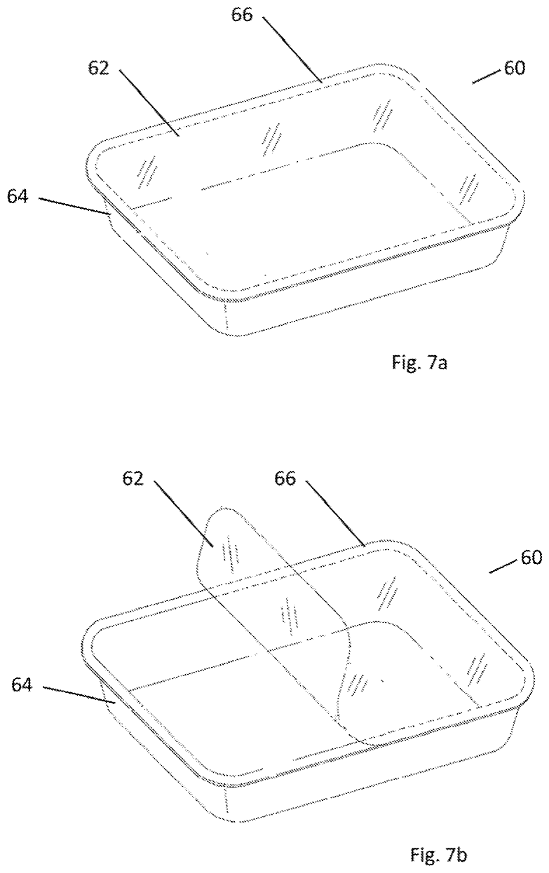

In some embodiments, the recyclable film is in the form of a lid that is attached to a tray or cup. The tray or cup may be flexible, semi-rigid or rigid and can be made of any material including, but not limited to, polyester, polyethylene, polystyrene, polypropylene, paper, metal, glass or ceramic. This embodiment is shown in FIGS. 7a and 7b. The package 60 has a lid 62 connected to a tray 64 by a heat seal 66. FIG. 7a is a hermetically sealed package 60, while FIG. 7b shows the package 60 after the lid 62 has been manually peeled away from the tray 64. The lid 62, the tray 64 or both the lid and the tray may be a recyclable film.

The recyclable films described herein may also be used for applications that are not related to packaging.

Unless defined otherwise, all technical and scientific terms used herein have the same meanings as commonly understood by one of ordinary skill in the art to which this invention belongs. All publications and patents specifically mentioned herein are incorporated by reference for all purposes.

The following examples are offered for illustrative purposes only, and is not intended to limit the scope of the present invention in any way. Indeed, various modifications of the invention in addition to those shown and described herein will become apparent to those skilled in the art from the foregoing description and the following examples and fall within the scope of the appended claims.

Example Films

Example A: A coextruded film was produced on a blown film line with in-line machine direction orientation. The structure of the film was polyamide tie/PE/tie/polyamide. The polyimide used was 5034FDX40 (PA6/66 copolyamide available from UBE Industries, Ltd.). The center PE layer used a blend of mLLDPE (2705HH and 1018HA available from ExxonMobil™). The material was machine direction oriented by a factor of 3, in-line, and annealed at about 121° C. using two high diameter annealing rollers.

Example B: A coextruded film was produced on a blown film line with in-line machine direction orientation. The structure of the film was polyamide/tie/PE/tie/polyamide. The polyamide used was 5034FDX40 (PA6/66 copolyamide available from UBE Industries, Ltd.). The center PE layer used a HDPE (HtA 108 available from ExxonMobil™). The material was machine direction oriented by a factor of 3, in-line, and annealed at about 121° C. using two high diameter annealing rollers.

Example C: A coextruded film was produced on a flat die, having the structure of polyamide/tie/LLDPE/tie/polyamide. The polyamide used was a nylon 6 (Aegis® H135 available from AdvanSix. The LLDPE was Dowlex 2036G available from Dow. The layer distribution was 15%/10%/50%/10%/15%. The film was machine direction oriented by a factor of 3, in-line with coextrusion, and annealed at about 121° C. using two high diameter annealing rollers.

Comparative Example 1: Data was collected on a standard 48 ga OPET.

Comparative Example 2: Data was collected on a standard 60 ga BON.

Comparative Example 3: An all polyethylene film was run on a blown fill line and machine direction oriented in-line. The final film was 0.8 mil thickness.

Comparative Example 4: A 4 mil film was produced using a blown film coextrusion process. The structure was polyamide/tie/polyamide/EVOH/polyamide/tie/polyethylene. The structure was not oriented.

### Testing and Data

Loop Stiffness is tested using a tensile testing unit fit with an appropriate load cell and bending apparatus. The bending apparatus is generally an upper breaker plate and a holder. Film samples are cut to 4 inch×4 inch samples, noting machine direction of the film. Ten film samples are tested, five in each of the machine direction and the transverse direction. The test is run at a crosshead speed of 5 inches/minute. The film is inserted into the holder with the outside of the material facing up. For machine direction data, the sample is mounted with the machine direction perpendicular to the length of the holder. For transverse direction data, the sample is mounted with the transverse direction perpendicular to the length of the holder. The test is started with the upper crosshead lowered such that the bottom edge of the breaker plate is slightly above the looped top of the test specimen. The equipment should be set to stop after 0.5 inches. Individual readings of the stiffness (grams force) is recorded and the average is reported. Loop stiffness data is reported in Table 1. The data indicates that the base films disclosed herein have stiffness similar to BON and OPET films.

TABLE 1
Loop Stiffness Data

| Film Sample | Loop Stiffness (g force) MD/TD |
|---|---|
| Example A | 1.4/2.0 |
| Example B | 1.2/1.6 |
| Example C | 1.6/1.5 |
| Comp. Example 1 | 1.3/1.4 |
| Comp. Example 2 | 1.4/1.5 |

The tensile properties of a film play a critical role in processing during film converting as well as package performance. Base films with low elongation properties can be useful when printing during standard high-performance packaging printing operations, as previously described. Tensile properties of films were characterized using ASTM D882 and Elongation Percentage at Break is reported in Table 2. The data indicates that the elongation in the machine direction of the Example films is comparable to BON and OPET films. In comparison, an oriented film that does not contain polar layers (Comp. Example 3) has a significantly higher machine direction elongation percentage at break. Additionally, a film that contains polar layers but are not oriented (Comp. Example 4) has significantly higher machine direction elongation percentage at break. For converting films into high performance packaging, the machine direction elongation percentage at break is less than 100%.

TABLE 2
Tensile Elongation Percentage at Break

| | Tensile Elongation |
|---|---|
| Film Sample | Percentage at Break (MD/TD) |
| Example A | 70/417 |
| Example B | 45/439 |
| Example C | 31/198 |
| Comp. Example 1 | 91/78 |
| Comp. Example 2 | 69/71 |
| Comp. Example 3 | 127/604 |
| Comp. Example 4 | 391/408 |

“Free shrink” is defined to be values obtained by measuring unrestrained shrink at 90° C. for five seconds. Five test specimens are cut to 10 cm. in the machine direction by 10 cm. in the transverse direction. Each specimen is completely immersed for at least 5 seconds in a 90° C. water bath. The distance between the ends of the shrunken specimen is measured. The difference in the measured distance for the shrunken specimen and the original 10 cm. is multiplied by ten to obtain the percent of shrinkage for the specimen for each direction. The machine direction shrinkage for the five specimens is averaged for the machine direction shrinkage value of the given film sample, and the transverse direction shrinkage for the five specimens is averaged for the transverse direction shrinkage value. Free shrink data is given in Table 3.

TABLE 3
Free Shrink

| | Machine Direction (%) | Transverse Direction (%) |
|---|---|---|
| Example A | 10 | 2 |
| Example B | 5 | 1 |
| Example C | 6 | 0 |
| Comp. Example 1 | 0 | 0 |
| Comp. Example 2 | 1 | 2 |

Optical clarity was measured using the clarity port of a BYKGardner HazeGard in accordance with its instructions and the teaching of ASTM D-1003-13. Clarity is defined as the percentage of transmitted light that deviates from the incident light by less than 2.5 degrees. Clarity data (average of four measurements) is given in Table 4.

TABLE 4
Clarity

| | Optical Clarity (%) |
|---|---|
| Example A | 99.1 |
| Example B | 96.9 |
| Example C | 89.6 |
| Comp. Example 1 | 97.2 |
| Comp. Example 2 | 98.6 |

The degree of orientation imparted on a polymeric and transparent film was measured using the following test method. A light box (e.g. Porta Trace Light Box from Gagne, Inc.) is set up with a light polarizing film on the surface. This first polarizing film is mounted with the polarization direction oriented 45 degrees from the side edge of the light box. A second polarized film should be mounted 4 to 10 inches above the first polarizing film with the polarization direction oriented 90 degrees from the polarization direction of the first polarizing film. The sample of the film to be tested should be placed between the polarizing films with the machine direction of the film aligned with the side of the light box. The color of the film can be determined by viewing the sample through the second polarizing film after the light box has been turned on. The degree of orientation can be assessed by the colors seen. Films with little or no orientation appear to be black, gray or white (or likely a mix of these colors). As orientation increases, other colors appear, starting with, yellow and advancing through orange, blue, and purple. Often the colors are mixed or vary.

Various film structures were coextruded and tested for orient ion. Some of the film samples were oriented as well. The results can be seen in Table 5. The test results indicate how this test can be used to verify orientation of a film.

TABLE 5

| | Orientation Test Results |
|---|---|
| Film Description | (Color Observed) |
| Polyethylene film, | Green |
| machine direction oriented 6X | |
| Polyethylene film, | Yellow |
| machine direction oriented 3X | |
| Polyamide/Polyethylene film, | Orange/Blue/Green |
| machine direction oriented 2X | |
| Polyamide film, | Blue/Green/Purple |
| machine direction oriented 2.5X | |
| Polyamide film, | Blue/Green/Purple |
| machine direction oriented 3.0X | |
| Polyamide film, | Green/Purple |
| machine direction oriented 3.5X | |
| Polyamide/Polyethylene film, | White |
| no orientation | |

Reference throughout this specification to “one embodiment,” “certain embodiments,” “one or more embodiments” or “an embodiment” means that a feature, structure, material, or characteristic described in connection with the embodiment is included in at least one possible embodiment. Thus, the appearances of the phrases such as “in one or more embodiments,” “in certain embodiments,” “in one embodiment” or “in an embodiment” in various places throughout this specification are not necessarily referring to the same embodiment. Furthermore, the features, structures, materials, or characteristics may be combined in any suitable manner in one or more embodiments.

Unless otherwise indicated, all numbers expressing, sizes, amounts, ranges, limits, and physical and other properties used in the present application are to be understood as being preceded in all instances by the term “about”. Accordingly, unless expressly indicated to the contrary, the numerical parameters set forth in the present application are approximations that can vary depending on the desired properties sought to be obtained by a person of ordinary skill in the art without undue experimentation using, the teachings disclosed in the present application.

The description, examples, embodiments, and drawings disclosed are illustrative only and should not be interpreted as limiting. The present invention includes the description, examples, embodiments, and drawings disclosed; but it is not limited to such description, examples, embodiments, or drawings. As briefly described above, the reader should assume that features of one disclosed embodiment can also be applied to all other disclosed embodiments, unless expressly indicated to the contrary. Modifications and other embodiments will be apparent to a person of ordinary skill in the packaging arts, and all such modifications and other embodiments are intended and deemed to be within the scope of the present invention.

Exemplary Embodiments

A A recyclable film comprising:
a) a base film comprising;
   i) a first polar layer comprising a polar polymer, and
   ii) a compatibilizer layer comprising a polar polymer compatibilizer,
b) a sealant, and
c) optionally printed indicia located between the base film and the sealant,
wherein the base film is oriented and annealed such that the base film has a free shrink value of less than 10% in both the machine direction and the transverse direction when tested according to ASTM D2732 using bath temperature 90° C.

B A recyclable film comprising;
a) a base film comprising:
   i) a first polar layer comprising a first polar polymer,
   ii) a second polar layer comprising a second polar polymer, and
   iii) a compatibilizer layer located between the first polar layer and the second polar layer, the compatibilizer layer comprising a polar polymer compatibilizer; and
b) a sealant

C A recyclable film comprising a base film, the base film comprising:
a) a first outer layer comprising a polyamide;
b) a compatibilizer layer comprising,
   i) a polyethylene, polyethylene copolymer or blends thereof, and
   ii) a compatibilizer comprising a low molecular weight anhydride or carboxylic acid functionalized polyethylene;
c) a first tie layer located between the first outer layer and compatibilizer layer;
d) a second outer layer comprising a polyamide; and
e) a second tie layer located between the compatibilizer layer and the second outer layer.

D A recyclable film according Embodiment further comprising a sealant.

E A recyclable film according to any other Embodiment wherein the polar polymer is a polyamide or an ethylene vinyl alcohol copolymer.

F A recyclable film according to any other Embodiment wherein the first polar layer is an outer layer of the base film.

G A recyclable film according to any other Embodiment wherein the first polar layer is an outer layer of the recyclable film.

H A recyclable film according to any other Embodiment wherein the base film is oriented and annealed such that the base film has a free shrink value of less than 10% in both the machine direction and the transverse direction tested according to ASTM D2732 using bath temperature of 90° C.

I A recyclable film according to any other Embodiment wherein the base film has a free shrink value of less than 5% in both the machine direction and the transverse direction when tested according to ASTM D2732 using bath temperature of 90° C.

J A recyclable film according to any other Embodiment wherein the sealant is a film that has free shrink of less than 1% in the machine direction and a free shrink of less than 1% in the transverse direction when tested according to ASTM D2732 using bath temperature of 90° C.

K A recyclable film according to Embodiment B or D further comprising printed indicia between the base film and the sealant.

L A recyclable film according to any other Embodiment wherein the base film has been oriented such that the machine direction elongation at break of the base film is less than 100%

M A recyclable film according to Embodiment C wherein the polyethylene in the compatibilizing layer is a LLDPE.

N A recyclable film according to any other Embodiment further comprising a barrier material between the base film and the sealant.

O A recyclable film according to any other Embodiment, further comprising a second sealant, such that the base film is located between the sealants.

P A package comprising a recyclable film according to any of the previous Embodiments and optionally additional packaging components.

Q A package according to Embodiment P wherein the recyclable film is heat sealed to either itself or the additional packaging components and the heat seal strength is between 200 g/in and 2,500 g/in when tested according to ASTM F88.

R A package according to Embodiment P or Q wherein the recyclable film is configured to be separated from the other packaging components that may be present.

S A package according to Embodiment P, Q or R wherein the package is configured to be opened for complete product removal.

1. A recyclable film comprising:
a) a base film comprising:
i) a first polar layer comprising a polar polymer, and
ii) a compatibilizer layer comprising a polar polymer compatibilizer,
b) a sealant, and
c) printed indicia located between the base film and the sealant, wherein the base film is oriented and annealed such that the base film has a free shrink value of less than 10% in both the machine direction and the transverse direction when tested according to ASTM D2732 using bath temperature of 90° C.

2. A recyclable film according to claim 1 wherein the polar polymer is a polyamide or an ethylene vinyl alcohol copolymer.

3. A recyclable film according to claim 1 wherein the first polar layer is an outer layer of the base film.

4. A recyclable film according to claim 1 wherein the first polar layer is an outer layer of the recyclable film.

5. A recyclable film according to claim 1 wherein the base film has a free shrink value of less than 5% in both the machine direction and the transverse direction when tested according to ASTM D2732 using bath temperature of 90° C.

6. A recyclable film according to claim 1 wherein the sealant is a film that has free shrink of less than 1% in the machine direction and a free shrink of less than 1% in the transverse direction when tested according to ASTM D2732 using bath temperature of 90° C.

7. A recyclable film comprising:
a) a base film comprising:
i) a first polar layer comprising a first polar polymer,
ii) a second polar layer comprising a second polar polymer, and
iii) a compatibilizer layer located between the first polar layer and the second polar layer, the compatibilizer layer comprising a polar polymer compatibilizer; and
b) a sealant

8. A recyclable film according to claim 7 further comprising printed indicia between the base film and the sealant.

9. A recyclable film according to claim 7 wherein the base film is oriented and annealed such that the base film has a free shrink value of less than 10% in both the machine direction and the transverse direction tested according to ASTM D2732 using bath temperature of 90° C.

10. A recyclable film according to claim 7 wherein the base film has been oriented such that the machine direction elongation at break of the base film is less than 100%.

11. A recyclable film comprising a base film, the base film comprising:
a) a first outer layer comprising a polyamide;
b) a compatibilizer layer comprising,
i) a polyethylene, polyethylene copolymer or blends thereof, and
ii) a compatibilizer comprising a low molecular weight anhydride or carboxylic acid functionalized polyethylene;
c) a first tie layer located between the first outer layer and the compatibilizer layer;
d) a second outer layer comprising a polyamide; and
e) a second tie layer located between the compatibilizer layer and the second outer layer.

12. A recyclable film according to claim 11 wherein the polyethylene in the compatibilizing layer is a LLDPE.

13. A recyclable film according to claim 11 further comprising a sealant.

14. A recyclable film according to claim 11 wherein the base film is oriented and annealed such that the base film has a free shrink value of less than 10% in both the machine direction and the transverse direction when tested according to ASTM D2732 using bath temperature of 90° C.

15. A recyclable film according to claim 1, further comprising a barrier material between the base film and the sealant.

16. A recyclable film according to claim 1, further comprising a second sealant, such that the base film is located between the sealants.

17. A package comprising a recyclable film according to claim 1 and optionally additional packaging components.

18. A package according to claim 17 wherein the recyclable film is heat sealed to either itself or the additional packaging components and the heat seal strength is between 200 g/in and 2,500 g/in when tested according to ASTM F88.

19. A package according to claim 17 wherein the recyclable film is configured to be separated from the other packaging components that may be present.

20. A package according to claim 17 wherein the package is configured to be opened for complete product removal.
